(19) United States
(12) Patent Application Publication
(10) Pub. No.: US 2002/0033894 A1
(43) Pub. Date: Mar. 21, 2002

(54) SOLID STATE IMAGING APPARATUS

(76) Inventors: TOHRU WATANABE, GIFU (JP); MINORU HAMADA, GIFU (JP)

Correspondence Address: Wei-Fu Hsu Esq, Hogan & Hartson LLP, Biltmore Tower, 500 South Grand Avenue Suite 1900, Los Angeles, CA, 90071, US

(21) Appl. No.: 09/004,210

(22) Filed: Jan. 8, 1998

(30) Foreign Application Priority Data
Jan. 10, 1997 (JP) HEI 9-3113

(51) Int. Cl. H04N 5/335

(52) U.S. Cl. 348/312; 348/317

(57) ABSTRACT

An image sensor having a mosaic color filter mounted thereon synthesizes and takes out information charge of multiple pixels. In an image sensor (11), the number of bits of the odd-numbered columns of shift registers of a storage section (11s) is different from that of the even-numbered columns. During the transfer process of information charge from the storage section (11s) to a horizontal transfer section (11h), pixels are divided between the even-numbered columns and odd-numbered columns. The image sensor (11) discharges the information charge from an output section (11d) in response to a reset clock φr1 having a clock cycle twice as long as a horizontal clock φh, whereby the information charge is synthesized every two pixels. As the pixels are divided between the odd-numbered columns and the even-numbered columns, the information charge related to the same color component continues in the horizontal transfer section (11h). This prevents the mixture of different color components when two pixels are combined.

### BACKGROUND OF THE INVENTION

1. Field of the Invention

The present invention relates to a solid state imaging apparatus with a CCD image sensor, and more specifically, to improvement in photoreceptive sensitivity when capturing color images using an image sensor with a mosaic color filter.

2. Description of the Related Art

An imaging apparatus, such as a TV camera, which employs a CCD image sensor scans an image at a preset timing determined based on various sync signals produced according to a predetermined television system. For example, the vertical scanning period is set to 1/60 of a second and the horizontal scanning period is set to 2/525 of the vertical scanning period in the NTSC system, whereby the video information is sequentially output at a rate of one horizontal line each for one scene, and a continuous video signal is produced.

FIG. 1 shows a block diagram of the basic construction of an imaging apparatus using a CCD image sensor. The operation of such an imaging apparatus is illustrated in the form of a timing chart as shown in FIG. 2.

A frame transfer type CCD image sensor 1 is formed by an imaging section 1i, a storage section 1s, a horizontal transfer section 1h, and an output section 1d. The imaging section 1i consists of a plurality of parallel CCD shift registers arranged in a vertical direction. Each bit of these shift registers functions as a pixel and accumulates charge representative of information generated during the imaging period. The storage section 1s is also formed by a plurality of CCD shift registers which consist of equal numbers of bits and are arranged continuously from the imaging section 1i. The information charge of individual pixels of the imaging section 1i is transferred and output to the storage section is by driving the CCD shift registers of the imaging section 1i. Each bit of the shift registers of the storage section 1s temporarily stores the information charge of one pixel. The horizontal transfer section 1h consists of a line of CCD shift registers, each bit of which connects to the output of individual shift registers of the storage section 1s. Thus, the horizontal transfer section 1h receives the information charge transferred and output from the storage section 1s for each horizontal line, and sequentially transfers the charge to the output section 1d. The output section 1d is disposed on the output side of the horizontal transfer section 1h and has a capacitance for receiving the information charge. The output section 1d receives the information charge from the horizontal transfer section 1h in its capacitance and produces a voltage value corresponding to the received charge amount. The change of output voltage values represent an image signal Y0(t).

A driver circuit 2 consists of a frame clock generator 2f, a vertical transfer clock generator 2v, a horizontal clock generator 2h, a reset clock generator 2r, and a sampling clock generator 2s. The frame clock generator 2f generates a frame clock φf in response to a frame shift timing signal FT and supplies the clock to the imaging section 1i. The information charge accumulated in individual pixels of the imaging section 1i is transferred to the storage section 1s at a high speed every time one vertical scanning period is completed. The vertical transfer clock generator 2v generates a vertical transfer clock φv in response to vertical and horizontal sync signals VT, HT and supplies the clock to the storage section 1s. In response to this, the storage section 1s takes in the information charge supplied from the imaging section 1i in synchronism with the high speed transfer of the imaging section 1 and temporarily stores this information charge. The information charge is, in turn, transferred to the horizontal transfer section 1h from the storage section 1s one horizontal line each for every horizontal scanning period. The horizontal clock generator 2h generates a horizontal transfer clock φh in response to the horizontal sync signal HT and supplies the clock to the horizontal transfer section 1h. In response, the information charge, which has been taken in the horizontal transfer section 1h from the storage section 1s for each horizontal line, is sequentially output to the output section 1d. The reset clock generator 2r, generates a reset clock φr, which causes the sequential discharge of the information charge from the output section 1d, in synchronism with the operation of the horizontal clock generator 2h, and supplies the clock to the output section 1d. This causes the sequential discharge of the information charge of the output section 1d, which is supplied from the horizontal transfer section 1h, one pixel at a time. The sampling clock generator 2s generates a sampling clock φs, which causes the sequential sampling of the image signal Y0(t) supplied from the output section 1d, in synchronism with the operation of the horizontal clock generator 2h, as in the clock generator 2r. The sampling clock is then supplied to a sample-and-hold circuit 4 which will be described later in detail.

A timing control circuit 3 operates in accordance with a reference clock CLK having a fixed clock frequency. The timing control circuit 3 generates the vertical and horizontal sync signals VT, VH which determine the timing of vertical and horizontal scanning operations, respectively, of the image sensor 1, and supplies these signals to the driver circuit 2. Also, the timing control circuit 3 generates the frame shift timing signal FT at a frequency matching that of the vertical sync signal VT and supplies it to the driver circuit 2. In order to ensure that the image sensor 1 is exposed with a suitable amount of light, the shutter control is executed in the timing control circuit 3, so that the information charge of the imaging section 1i is discharged in the middle of the vertical scanning period corresponding to the amount of information charge generated in the imaging section 1i. Specifically, if the shutter operation timing is advanced, the period until the start of the frame transfer is extended, so that the information charge will be accumulated for a longer time period in the imaging section 1i. In contrast, if the shutter operation timing is delayed, the period until the start of the frame transfer is shortened, so that the accumulation of the information charge continues only for a short period of time in the imaging section 1i. The shutter operation for controlling the discharge of the information charge of the imaging section 1i is carried out in response to a driving clock supplied to the image sensor 1 from the driver circuit 2.

The sample-and-hold circuit 4 samples the image signal Y0(t) in response to the sampling clock φs supplied from the sampling clock generator 2s, to thereby generate an image signal Y1(t) which holds the signal level included in the signal Y0(t). Typically, the output section 1d repeatedly charges/discharges its capacitance at a timing according to the reset clock φr, so that the image signal Y0(t) produced in the output section 1d has alternate signal levels for the reset level and the signal level corresponding to the amount of the information charge. The sampling clock φs has a phase so that only the signal level of the image signal Y0(t) can be taken out. As a result, it is possible to obtain the image signal Y1(t) in which only the signal level continues corresponding to the information charge amount.

A frequency dividing circuit 5 is formed by a first frequency divider 5a which divides the frequency of the reset clock φr and a second frequency divider 5b which divides the frequency of the sampling clock φs. The frequency dividing circuit 5 divides the frequency of either the reset clock φr or the sampling clock φs, as needed, to intermittently reset the output section 1d, whereby the information charge of multiple pixels can be mixed in the output section 1d. For example, as shown in FIG. 3, the frequency dividing circuit 5 divides the frequency of the reset clock φr0 and the sampling clock φs0, both having the same frequency as the horizontal clock φh, in half to obtain the reset clock φr1 and the sampling clock φs1 which have twice as long clock cycle as the horizontal clock φh. These clocks are supplied to the output section 1d and the sample-and-hold circuit 4, respectively. In response to the reset clock φr1 whose frequency has been doubled, the information charge is discharged every time the information charge of two pixels is stored in the output section 1d. Thus, it is possible to obtain the image signal Y0(t) with approximately doubled signal level.

The imaging section 1i of the image sensor 1 accumulates the information charge of one scene for the maximum of one vertical scanning period. There are cases, however, where an object to be imaged by the image sensor 1 is dark and a sufficient amount of light cannot be obtained even when the charge is accumulated for up to the maximum period. In such a case, the frequency dividing circuit 5 is operated to thin out the frequency of the reset of the information charge in the output section 1d and reduce it by half, so that the information charge of two pixels can be taken out as the charge of one pixel. This allows the image signal Y1(t) having a sufficient signal level to be obtained without causing the lack of exposure, even for a dark object.

For color imaging by the imaging apparatus, a color filter is attached to the imaging section 1i of the image sensor 1 in such a manner that each pixel corresponds to one of the predetermined color components. The color filter consists of segments of different colors arranged two-dimensionally corresponding to three primary colors or their complementary colors. Each segment corresponds to one pixel, and is assigned respective colors in a predetermined order. For example, in the mosaic filter, white (W) and green (G) are alternately assigned to the segments of odd-numbered lines, while cyan (Cy) and yellow (Ye) are alternately assigned to the segments of even-numbered lines.

When the above color filter is mounted on the imaging section 1i of the image sensor 1, two horizontally adjacent pixels are related to different color components, so that the information charges accumulated in those adjacent pixels, in turn, represent different color components. In this case, if the information charge of two pixels are synthesized to obtain the image signal Y0(t) in the output section, color components may be mixed, thereby inhibiting the correct reproduction of all color components in the subsequent signal processing. This is especially disadvantageous when a mosaic filter is used, because separating the color components is very difficult due to color component arrangement during the processing of the image signal Y1(t).

### SUMMARY OF THE INVENTION

An object of the present invention is, therefore, to provide the ability to synthesize the information charge of two pixels in an image sensor with attached color filter.

A solid state imaging apparatus according to the present invention comprises a solid state imaging device including a plurality of pixels arranged in a matrix form corresponding to each segment of a color filter, each column of the pixels being connected to a plurality of vertical transfer section, each output of the plurality of vertical transfer sections being connected to each bit of a horizontal transfer section, and the amount of information charge of the horizontal transfer section being converted to a voltage value and output from an output section; a driver circuit for transferring the information charge accumulated in the plurality of pixels to the plurality of vertical transfer section, to the horizontal transfer section for every horizontal line, and then to the output section, the driver circuit further discharging the information charge stored in the output section in synchronism with the transfer operation of the horizontal transfer section; and a detecting circuit for taking out the voltage value from the output section in synchronism with the discharge operation of the driver circuit.

In this apparatus, the driver circuit forces the solid state imaging device to transfer the information charge alternately from odd-numbered columns and even-numbered columns of the plurality of vertical transfer sections, and, by setting the discharge cycle of the output section to an integral multiple of the transfer cycle of the horizontal transfer section, the driver circuit forces the output section to store and output the information charge of more than one pixels.

According to the present invention, if every other column of the pixels of the solid state imaging device is related to the same color component, the information charge is transferred from the vertical transfer sections to the horizontal transfer section for every other column of the pixels. In this way, the horizontal transfer section simultaneously receives the information charge related to the same color component. Thus, the information charge of more than two pixels can be synthesized on the output side of the horizontal transfer section without mixing different color components.

### BRIEF DESCRIPTION OF THE DRAWINGS

FIG. 1 is a block diagram showing the structure of a conventional solid state imaging apparatus.

FIG. 2 is a timing chart illustrating a first operation of the conventional solid state imaging apparatus.

FIG. 3 is a timing chart illustrating a second operation of the conventional solid state imaging apparatus.

FIG. 4 is a block diagram showing the structure of a solid state imaging apparatus according to the present invention.

FIG. 5 is a plan view showing the configuration of a mosaic color filter.

FIG. 6 is a plan view showing an example of the connection between a storage section and a horizontal transfer section of an image sensor.

FIG. 7 is a timing chart illustrating a first operation of the solid state imaging apparatus of the present invention.

FIG. 8 is a timing chart illustrating a second operation of the solid state imaging apparatus of the present invention.

FIG. 9 is a timing chart illustrating an arrangement of color components of an image signal output from the image sensor with the mosaic color filter attached to it.

FIG. 10 is a timing chart illustrating a third operation of the solid state imaging apparatus of the present invention.

FIG. 11 is an example of a first pixel combination for synthesizing information charge.

FIG. 12 is an example of a second pixel combination for synthesizing information charge.

### DESCRIPTION OF THE PREFERRED EMBODIMENT

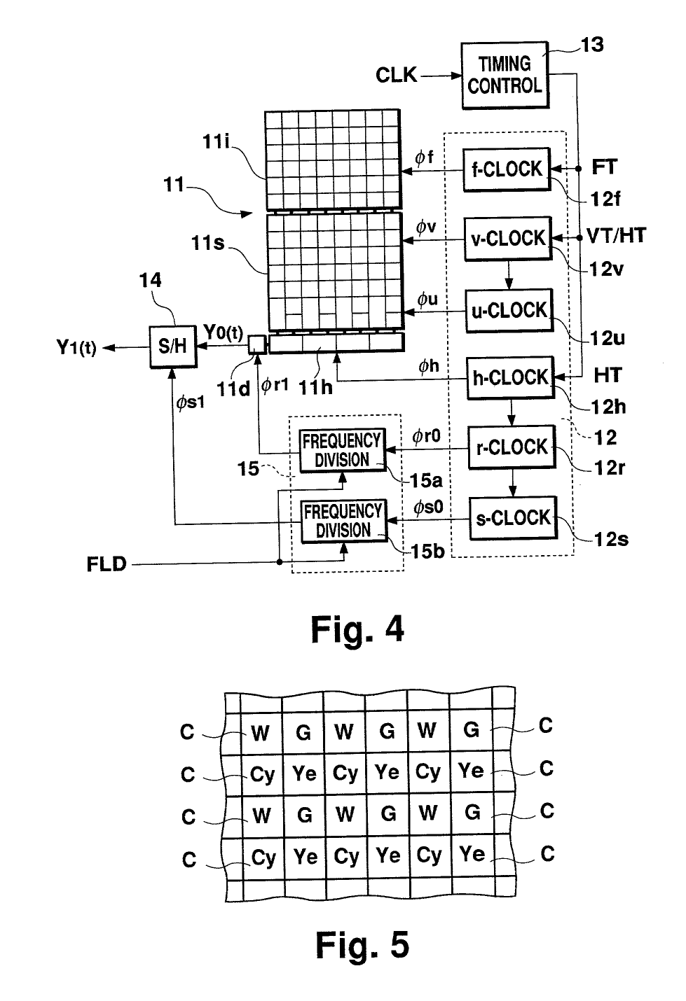

FIG. 4 is a block diagram showing the configuration of a solid state imaging apparatus according to the present invention. FIG. 5 is a plan view of a mosaic color filter attached to an image sensor 11 used in the solid state imaging apparatus of the present invention.

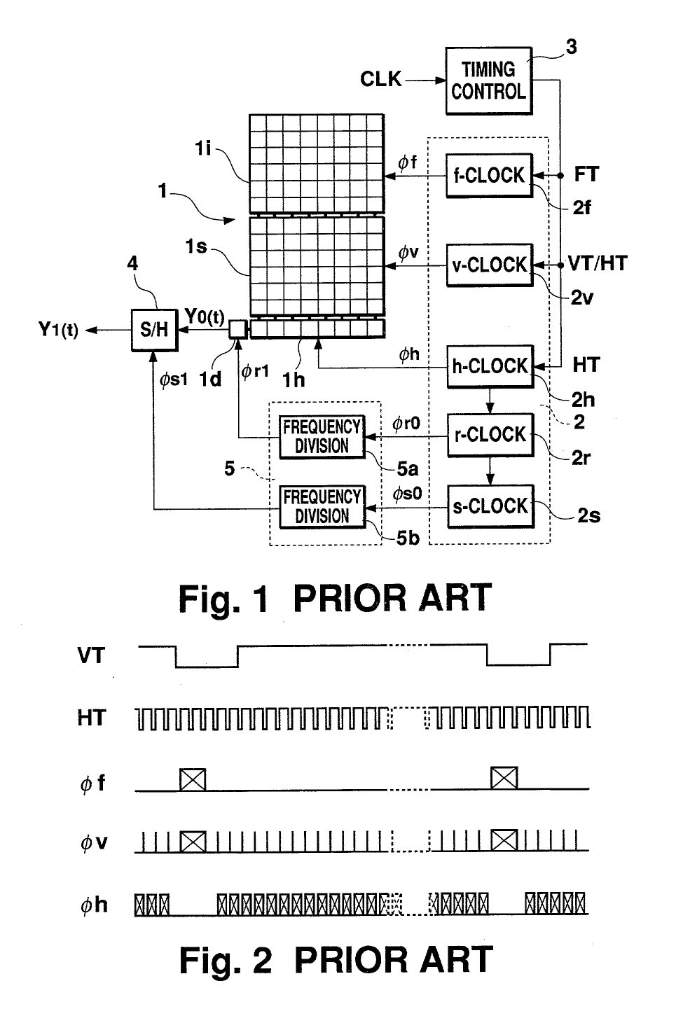

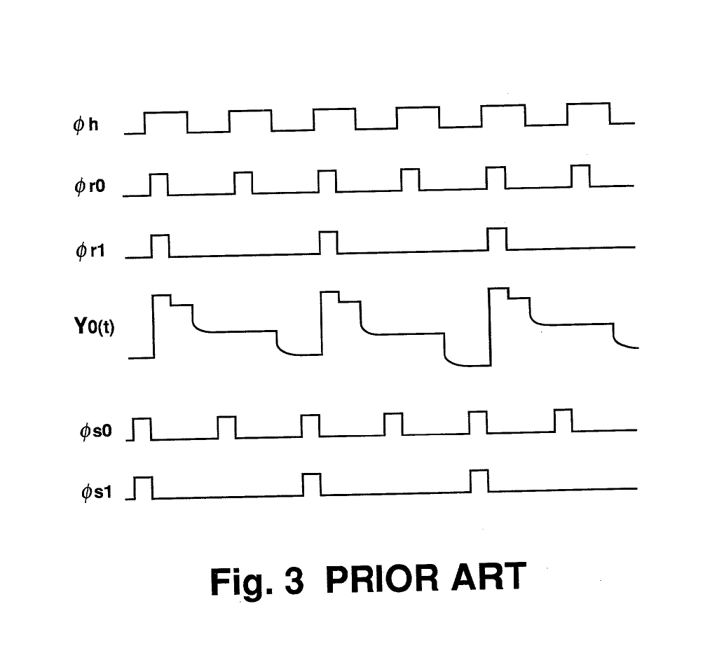

Like the image sensor shown in FIG. 1, a frame transfer type CCD image sensor 11 is formed by an imaging section 11i, a storage section 11s, a horizontal transfer section 11h, and an output section 11d. The imaging section 11i consists of a plurality of parallel CCD shift registers arranged in a vertical direction. Each bit of these shift registers functions as a pixel which accumulates information charge generated during the imaging period. The storage section 11s is formed by a plurality of CCD shift registers which consist of at least the same number of bits as the imaging section 11i, and are arranged continuously from the imaging section 11i. The information charge of individual pixels is transferred and output to the storage section 11s by driving the CCD shift registers of the imaging section 11i. Each bit of the shift registers of the storage section 11s temporarily stores the information charge of one pixel. The shift registers of the storage section 11s are arranged so that even-numbered columns have one additional bit at the connection of the horizontal transfer section 11h. The horizontal transfer section 11h consists of a line of CCD registers, each bit of which connects to the output of individual shift registers of the storage section 11s. The horizontal transfer section 11h receives the information charge transferred and output from the storage section 11s, and sequentially transfers the charge to the output section 11d. Each bit of the shift registers of the horizontal transfer section 11h corresponds to two columns, and each of the shift registers constitutes the imaging section 11i and the storage section 11s. The output section 11d is disposed on the output end of the horizontal transfer section 11h, and has a capacitance for receiving the information charge. The output section 11d receives the information charge from the horizontal transfer section 11h in its capacitance, and produces a voltage value corresponding to the received charge.

The imaging section 11i of the image sensor 11 is provided with the mosaic color filter as shown in FIG. 5. The color filter is divided into a plurality of segments C, each of which corresponds to one pixel of the imaging section 11i. Each segment C is related to a predetermined color component. For example, if four color components, e.g., white (W), green (G), yellow (Ye), and cyan (Cy), are used, the segments C of odd-numbered lines are alternately related to W and G, while those of even-numbered lines are alternately related to Ye and Cy. Thus, the information charge corresponding to the W and G components is accumulated alternately in the columns of the odd-numbered lines of pixels, while the information charge corresponding to the Ye and CY components is accumulated alternately in the columns of the even-numbered lines.

A driver circuit 12 is formed by a frame clock generator 12f, a vertical transfer clock generator 12v, an auxiliary clock generator 12u, a horizontal clock generator 12h, a reset clock generator 12r, and a sampling clock generator 12s. The frame clock generator 12f generates a frame clock φf in response to a frame shift timing signal FT and supplies the clock to the imaging section 11i. In response to this, the information charge accumulated in individual pixels of the imaging section 11i is transferred to the storage section 11s at a high speed every time one vertical scanning period is completed. The frame clock generator 12f is identical to the one included in the driver circuit 2 of FIG. 1. The vertical transfer clock generator 12v generates a vertical transfer clock φv in response to vertical and horizontal sync signals VT, HT and supplies the clock to the storage section 11s. The auxiliary clock generator 12u generates an auxiliary clock φu having half the frequency of the vertical transfer clock φh in response to the horizontal sync signal HT, and supplies the clock to the additional bit disposed on the output end of the even-numbered columns of the storage section 11s. Thus, the storage section 11s takes in the information charge output from the imaging section 11i in synchronism with the high speed transfer of the imaging section 11i, temporarily stores the charge, and transfers it for alternate odd-numbered columns and even-numbered columns, i.e., for every half line, for every half of the horizontal scanning period.

The horizontal clock generator 12h generates the horizontal transfer clock φh in response to the horizontal sync signal HT and supplies the clock to the horizontal transfer section 11h. As the number of bits has been reduced in half in the horizontal transfer section 11h, the transfer of the information charge, which is taken in the horizontal transfer section 11h, to the output section 11d is completed in half the horizontal scanning period. Such a half line transfer of the information charge will be repeated twice during one horizontal scanning period to complete the one-line transfer of the information charge. The reset clock generator 12r generates the reset clock φr, which causes the sequential discharge of the information charge of the output section 11d, in synchronism with the operation of the horizontal clock generator 12h, and supplies the clock to the output section 11d. In response to this, the information charge of the output section 11d, which has been transferred from the horizontal transfer section 11h, is discharged pixel by pixel. The sampling clock generator 12s generates a sampling clock φs, which causes the sequential sampling of the image signal Y0(t) from the output section 11d, in synchronism with the operation of the horizontal clock generator 12h, as in the reset clock generator 12r. The sampling clock φs is then supplied to the sample-and-hold circuit which will be described later.

In the case where a mosaic color filter as shown in FIG. 5 is attached to the imaging section 11i of the image sensor 11, the information charge of the storage section 11s is transferred to the horizontal transfer section 11s every other column (i.e., separately for odd-numbered columns and even-numbered columns). As a result, the same color component continues for half the horizontal scanning period.

A timing circuit 13 generates the vertical and horizontal sync signals VT, HT which determine the respective vertical and the horizontal scanning timing and also generates the frame transfer timing signal FT at a frequency matching the vertical sync signal VT. These signals are then supplied to the driver circuit 12. It is noted that the timing circuit 13 is identical to the timing circuit 3 of FIG. 1.

The sample-and-hold circuit 14 samples the image signal Y0(t) output from the image sensor 11 in response to the sampling clock φs supplied from the sampling clock generator 12s. Typically, the output section 11d repeatedly charges/discharges its capacitance at a timing according to the reset clock φr, so that the levels of the reset level and the signal level of image signal Y0(t) produced in the output section 11d alternate. The sampling clock φs has a phase so that only the signal level of the image signal Y0(t) can be taken out. As a result, it is possible to obtain the image signal Y1(t) in which only the signal level continues corresponding to the information charge amount.

A frequency dividing circuit 15 is formed by a first frequency divider 15a which divides the frequency of the reset clock φr, and a second frequency divider 15b which divides the frequency of the sampling clock φs. The frequency dividing circuit 15 divides both the reset clock φr and the sampling clock φs at the same ratio to intermittently reset the output section 11d, whereby the information charge of multiple pixels can be mixed in the output section 11d. For example, the frequency dividing circuit 5 divides the frequency of the reset clock φr0 and the sampling clock φs0, both having the same frequency as the horizontal clock φh, in half to obtain the reset clock φr1 and the sampling clock φs1 which have twice as long period as the horizontal clock φh. The resulting clocks are then applied to the output section 11d and the sample-and-hold circuit 14, respectively. The frequency dividers 15a, 15b shift the frequency dividing timing one clock cycle each for a vertical scanning period in response to a frame identification signal FLD which is inverted every vertical scanning period. This horizontally shifts the combination of pixels to be synthesized in the output section 11d one pixel for each vertical scanning period, thereby attempting to minimize the deterioration of resolution caused by synthesizing the pixels.

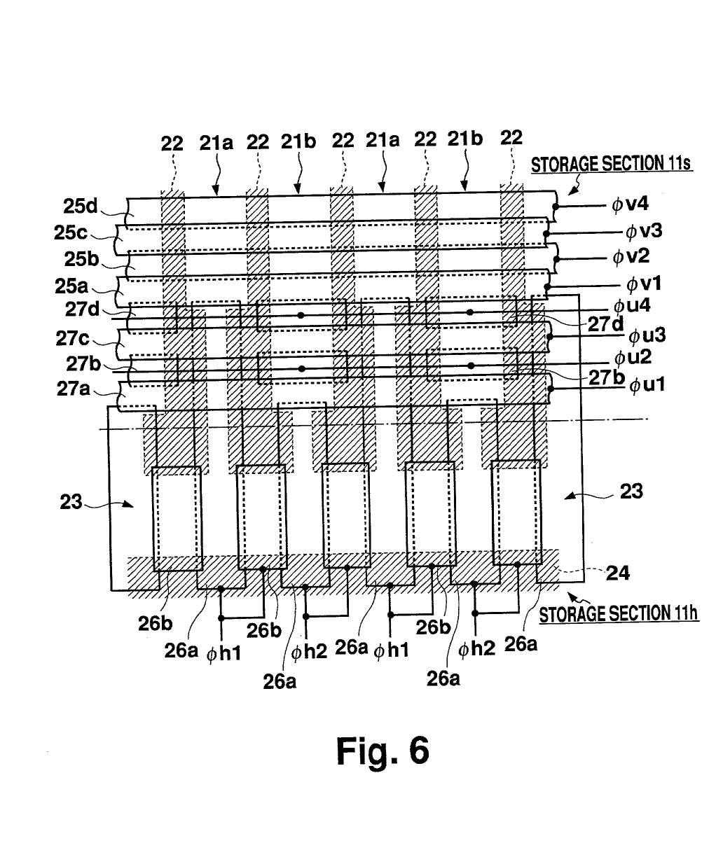

FIG. 6 is a plan view showing an example of the connection between the storage section 11s and the horizontal transfer section 11h of the image sensor

A plurality of vertical transfer channels 21a, 21b vertically extend in parallel along a transfer direction, with an isolation area 22 separating these channels from each other. At the output end of the vertical transfer channels 21a, 21b, a horizontal transfer channel 23 extends horizontally with an isolation area 24 disposed in-between. A plurality of transfer electrodes 25a-25d arranged in two layers extend horizontally on the plurality of vertical transfer channels 21a, 21b so as to uniformly cover every column of the transfer channels. The electrodes 25a-25d are arranged in parallel and electrically isolated from each other. Four vertical transfer clocks φv1-φv4, each having a different phase, are applied to the transfer electrodes 25a-25d, respectively. A plurality of transfer electrodes 26a, 26b arranged in two layers extend vertically on the horizontal transfer channel 23. Two adjacent transfer electrodes 26a and 26b form a pair and are electrically connected to each other. Each electrode pair alternately receives a horizontal clock φh1 or φh2, each having a different phase, in the order of arrangement. The lower electrode 26a extends up to the vertical channels 21a, 21b so as to cover the connection between the vertical transfer channels 21a, 21b and the horizontal transfer channel 23. In addition, the connection between the odd-numbered columns of vertical transfer channel 21a and the horizontal transfer channel 23 is a bit longer than the connection between the even-numbered columns. The lengthened part is also covered by the transfer electrode 26a.

Auxiliary transfer electrodes 27a-27d having a two-layered structure are formed on the output side of the vertical transfer channels 21a, 21b, or on the side of the horizontal transfer channel 23. Lower auxiliary electrodes 27b, 27d are only provided on the even-numbered columns of the vertical transfer channel 21b. Although arranged across every vertical transfer channel 21a, 21b, the upper auxiliary electrodes 27a, 27c overlap the transfer electrode 26a, and only concern the even-numbered columns of the vertical transfer channel 21b. The auxiliary transfer electrodes 27a-27d receive the auxiliary clocks φu1-φu4, respectively, where each clock has a different phase. In this arrangement, the auxiliary transfer electrodes 27a-27d form one auxiliary bit at the output end of the even-numbered columns of the vertical transfer channel 21b, whereby the information charge of one pixel can be temporality stored in these even-numbered columns in the process of transferring the information charge from the storage section 11s to the horizontal transfer section 11h.

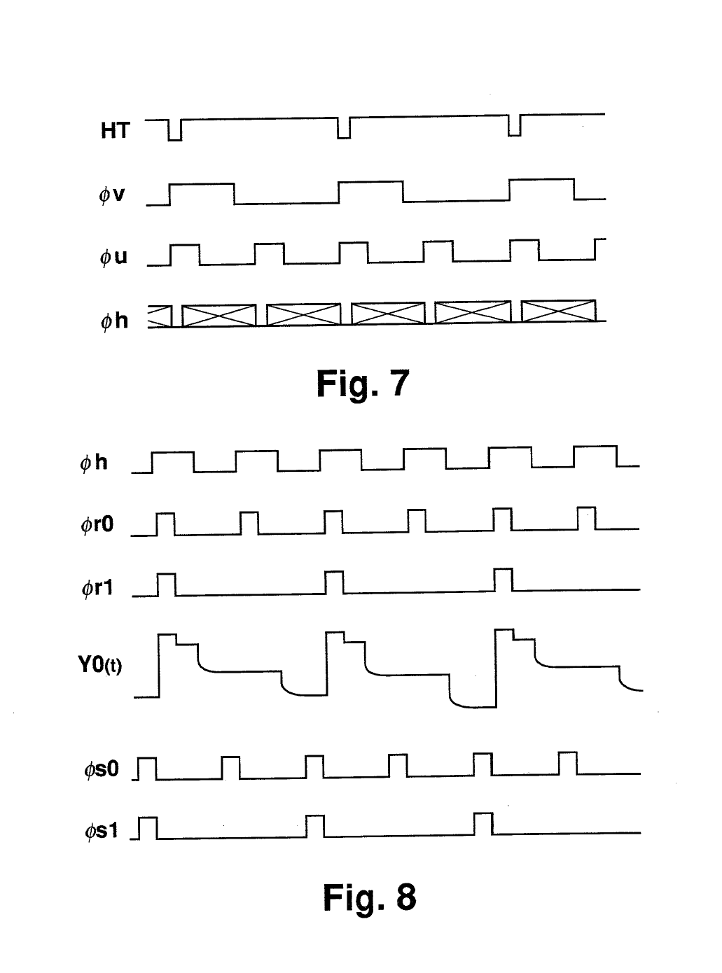

FIGS. 7 and 8 are timing charts showing the operation of the solid state imaging device of FIG. 6, wherein FIG. 7 shows the operation correspond to the horizontal scanning frequency and FIG. 8 shows the operation correspond to the horizontal clock frequency. It should be noted that, in practice, the vertical transfer clock φv and the auxiliary clock φu have four phases and the horizontal clock φh has two phases, but only representative clocks are shown in the figures.

As seen in FIG. 7, the vertical transfer clock φv sends a clock to the transfer electrodes 25a-25d at a frequency in accordance with the frequency of the horizontal sync signal HT, to thereby vertically transfer the information charge in the vertical transfer channel 21a, 21b pixel by pixel for one horizontal scanning period. The auxiliary clock φu has a frequency equivalent to one-half of the vertical transfer clock φv, and sends a clock to the auxiliary transfer electrodes 27a-27d once within half of the cycle of the horizontal sync signal HT. The auxiliary transfer electrodes 27a-27d only control the vertical transfer of the even-numbered columns, or the vertical transfer channel 21b, so that the vertical transfer of the information charge is delayed at the auxiliary bit formed at the output end. At the clocking speed of the auxiliary clock φu, it is possible to vertically transfer two packets each for one horizontal scanning period. However, it is only possible to transfer the information charge of one pixel during one horizontal scanning period from the transfer electrodes 25a-25d to the downstream bit of the auxiliary transfer electrode 27a-27d. This brings about a situation where one of two packets, which are transferred from the auxiliary bit to the horizontal transfer section during one horizontal scanning period, is empty. The empty transfer occurs every other packet. Thus, the odd-numbered vertical transfer channel 21a outputs the information of one pixel to the horizontal transfer channel 23 at a timing shifted by half the horizontal scanning period from that of the even-numbered vertical transfer channel 21b.

The horizontal clock φh is enabled in response to the vertical transfer clock φv and the auxiliary clock φu to send a clock to the transfer electrodes 26a, 26b at a frequency sufficiently shorter than the horizontal scanning period. The frequency of the horizontal clock φh is set so that every information charge in the horizontal transfer channel 23 can be transferred within half the horizontal scanning period, and that a predetermined blanking period can be secured. This allows the transfer of the information charge from the odd-numbered vertical transfer channel 21a during the first half of the horizontal scanning period, while the information charge of the even-numbered vertical transfer channel 21b is transferred during the second half thereof.

As seen from FIG. 8, the reset clock φr0 is synchronized with the horizontal clock φh. The frequency-divided clock φr1, which is generated by dividing the frequency of the reset clock φr0 in half, causes the discharge of the information charge accumulated in the output section 11d at a clock cycle twice as long as the horizontal transfer cycle. The frequency-divided clock φr1 is applied to the output section 1d of the image sensor 11. In this way, the output section 11d of the image sensor 11 accumulates the information charge of two pixels at a time. The resulting image signal Y0(t) progressively changes its signal level into two stages after the reset period determined by the frequency-divided clock φr1.

The sampling clock φs0 has the same frequency as the reset clock φr0, and causes the signal level of the image signal Y0(t) to be sampled at a sampling timing immediately before the reset period of the reset clock φr0. The frequency-divided sampling clock φs1 is obtained by dividing the frequency of the sampling clock φs0 in half and causes the image signal Y0(t) to be sampled at a clock cycle twice as long as the sampling clock φs0 in the sample-and-hold circuit 14. The frequency-divided sampling clock φs1 is applied to the sample-and-hold circuit 14 which receives the image signal Y0(t). After the reset period designated by the frequency-divided reset clock φr1, the second level of two signal levels of the image signal Y0(t) is sampled and the image signal Y1(t) is generated in which the signal level is held for two clock cycles, which is equivalent to two clock cycles of the horizontal clock φh.

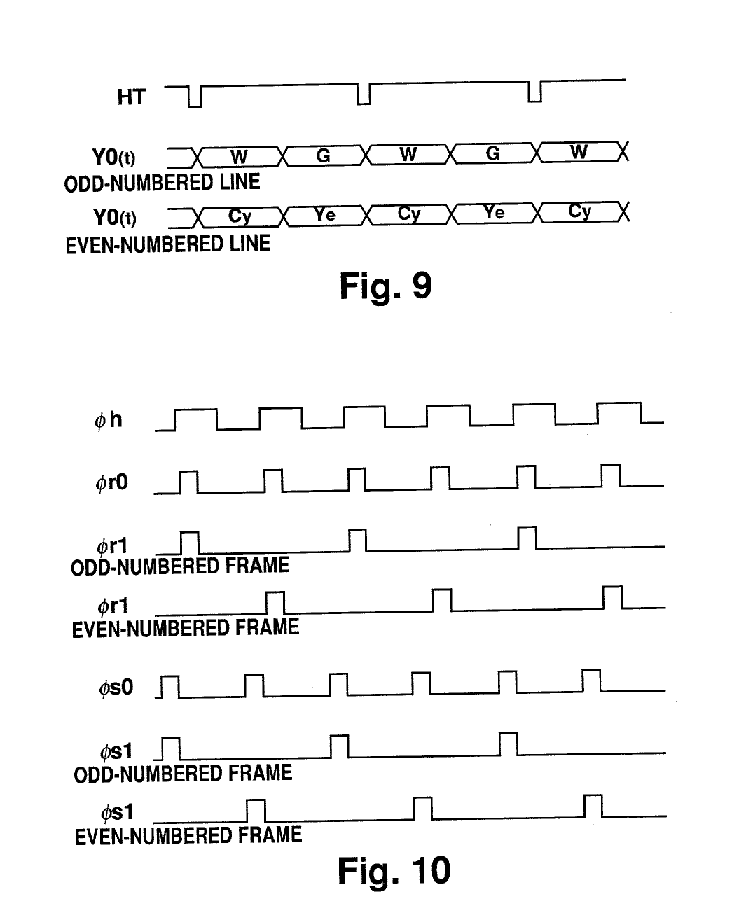

In the above-described image sensor 11 with attached mosaic color filter as shown in FIG. 5, each color component continues for half the horizontal scanning period. For example, as shown in FIG. 9, in the image signal Y0(t) which corresponds to the odd-numbered line of pixels alternately related to the W component and the G component, the W component continues in the first half of the horizontal scanning period, while the G component continues in the second half. Similarly, in the image signal Y0(t) which corresponds to the even-numbered line of pixels alternately related to the Cy component and the Ye component, the Cy component continues in the first half of the horizontal scanning period and the Ye component continues in the second half. This means that different color components will not be mixed when the information charge of two pixels are synthesized horizontally, whereby the signal can be processed appropriately in the signal processing circuit.

Because the image signal Y0(t) is obtained by synthesizing the information charge of two pixels, the horizontal resolution is decreased in half, compared to where the information charge of two pixels are not synthesized, which inevitably deteriorates image quality. One possible solution is to establish a pseudo interlace system in which the combination of two pixels used for synthesizing the information charge is switched for each vertical scanning period, to thereby minimize the deterioration of the image quality.

FIG. 10 is a timing chart illustrating the switching operation of the two pixel combinations used for synthesizing the information charge between the odd-numbered vertical scanning period, odd-numbered frames, and the even-numbered scanning period even-numbered frames.

As shown in FIG. 10, in the frequency-divided reset clock φr1, the frequency dividing timing, or the timing of thinning out pulses, is shifted by one clock cycle between the odd-numbered frames and the even-numbered frames. Similarly, the frequency dividing timing of the frequency-divided sampling clock φs1 is shifted by one clock cycle between the odd-numbered frames and the even-numbered frames, as shown in FIG. 10. Thus, both the frequency-divided clock φr1 and the frequency-divided sampling clock φs1 have a clock cycle twice as long as that of the reset clock φr0 and the sampling clock φs0, with the phase difference of half cycle each between the even-numbered frames and the odd-numbered frames. By using such frequency-divided clocks φr1 and φs1, it is possible to produce the image signal Y1(t) in which the combinations of two pixels synthesized at the output section 11d of the image sensor 11 are switched between the odd-numbered frames and the even-numbered frames.

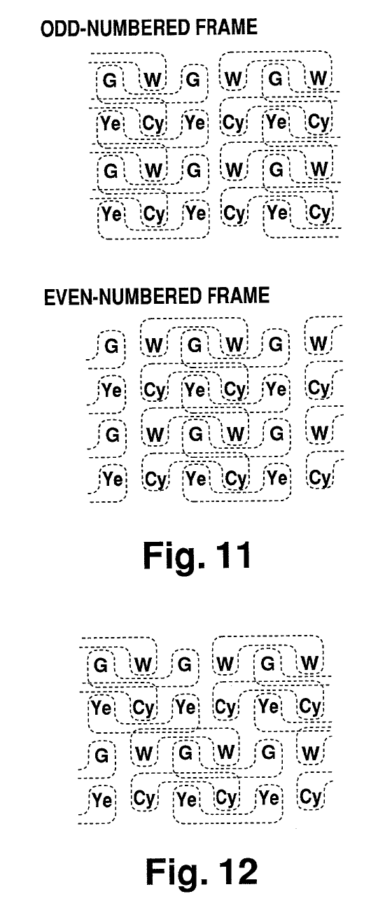

In the image sensor 11 with the color filter as shown in FIG. 5 is attached to it, the combination of two pixels used for synthesizing the information charge, those pixels corresponding to the same color component located every other pixel, switches between the odd-numbered frames and the even-numbered frames as indicated by broken lines of FIG. 11. Specifically, regarding the G component, for example, 4n and 4n+2 columns are combined in the odd-numbered frames, where n is an integer, while 4n−2 and 4n columns are combined in the even-numbered frames. This principle is applicable for all color components. Thus, the image sensor 11 can horizontally scan in a pseudo interlaced manner, and thereby prevent the deterioration of the horizontal resolution.

Switching the combinations of two pixels for synthesizing the information charge may by carried every horizontal scanning period instead of every vertical scanning period. In this case, the combinations of two pixels to be synthesized are switched every two lines, as shown in FIG. 12. This means that the combination of two pixels of a particular color component is switched every other line. Thus, the image sensor 11 horizontally scans in a pseudo interlaced manner, whereby the deterioration of the horizontal resolution can be prevented, as in the example shown in FIG. 11. It should be noted that a further effect can be expected if the switch of combinations is carried out for both vertical and horizontal scanning periods.

In the above-described embodiment, the information charge is synthesized for each two pixels, but more than three pixels may also be used to synthesize the information charge. This is easily done by changing the frequency dividing ratio used for producing the frequency-divided reset clock φr1 and the frequency-divided sampling clock φs1 from the reset clock φr0 and the sampling clock φs0, respectively.

In accordance with the invention, even image sensors with mosaic color filters can synthesize and take out the information charge of two pixels in a horizontal direction. This is realized without mixing different color components, so that the output image signals can be processed correctly in subsequent steps.

As described above, it is possible to increase the sensitivity of the imaging apparatus used for color imaging, while preventing the deterioration of the resolution associated with the sensitivity increase, to thereby provide the imaging apparatus having high sensitivity and high resolution.

While there has been described what is at present considered to be a preferred embodiment of the invention, it will be understood that various modifications may be made thereto, and it is intended that the appended claims cover all such modifications as fall within the true spirit and scope of the invention.

What is claimed is:

1. A solid state imaging apparatus, comprising:
a solid state imaging device including a plurality of pixels arranged in a matrix form corresponding to each segment of a color filter, each column of said pixels being connected to a plurality of vertical transfer sections, each output of said plurality of vertical transfer sections being connected to a corresponding bit of a horizontal transfer section, and the amount of information charge output from said horizontal transfer section being converted to a voltage value at an output section;
a driver circuit for transferring the information charge accumulated in said plurality of pixels to said plurality of vertical transfer sections, to said horizontal transfer section for every horizontal line, and then to said output section, said driver circuit further discharging the information charge stored in said output section in synchronism with the transfer operation of said horizontal transfer section; and
a detecting circuit for taking out a voltage value from said output section in synchronism with the discharge operation of said driver circuit, wherein:
said driver circuit forces said solid state imaging device to transfer the information charge alternately from odd-numbered columns and even-numbered columns of said plurality of vertical transfer sections, and
by setting the discharge cycle of said output section to an integral multiple of the transfer cycle of said horizontal transfer section, said driver circuit forces said output section to store and output the information charge of multiple pixels.

2. The solid state imaging apparatus according to claim 1, wherein said driving circuit shifts the discharge timing of said output section by one transfer cycle of said horizontal transfer section during each vertical or horizontal scanning period of said solid state imaging device subjected to the vertical and horizontal scanning.

3. The solid state imaging apparatus according to claim 1, wherein said driver circuit further comprises:
a vertical transfer clock generator operated in accordance with a reference clock having a fixed frequency for generating a vertical transfer clock which causes the information charge of said vertical transfer sections to be transferred to said horizontal transfer section one horizontal line each for every horizontal scanning period,
a horizontal transfer clock generator for generating a horizontal transfer clock which causes the information charge of said horizontal transfer section to be transferred to said output section in synchronism with said vertical transfer clock generator,
a reset clock generator for generating a reset clock which causes the information charge of said output section to be discharged in synchronism with said horizontal clock generator, and
a frequency dividing circuit for dividing the frequency of said reset clock by a factor of n, where n is an integer, and applying the resulting reset clock to said output section.

4. The solid state imaging apparatus according to claim 3, wherein said driver circuit further comprises:
a sampling clock generator for generating a sampling clock which causes the output voltage value from said output section to be taken in by said detecting circuit, with a certain phase difference being maintained relative to the operation of said reset clock generator, and
a frequency dividing circuit for dividing the frequency of said sampling clock by a factor of n, where n is an integer, and applying the resulting sampling clock to said detecting circuit.

5. A solid state imaging apparatus, comprising a solid state imaging device including:
a plurality of pixels arranged in a matrix form for generating and accumulating information charge corresponding to incident light;
a color filter mounted on said plurality of pixels and including a plurality of segment types being arranged regularly on said color filter, each of said plurality of segment types transmitting light of a different color component;
a plurality of vertical shift registers arranged in parallel for temporarily storing and vertically transferring a plurality of information charge packets read from said pixels;
a horizontal shift register for sequentially receiving said information charge packets output from each of said vertical shift registers, and horizontally transferring said plurality of information charge packets; and
an output section for storing said information charge output from said horizontal shift register for every horizontal transfer period, and supplying a voltage signal corresponding to the amount of stored information charge, and
said solid state imaging apparatus further comprises a driver circuit for transferring said information charge from said pixels to said vertical shift registers, causing the vertical transfer of said vertical shift registers, causing the horizontal transfer of said horizontal shift register, and discharging said information charge stored in said output section, wherein:
said information charge packets are transferred from said vertical shift registers to said horizontal shift register alternately between a group of odd-numbered columns and a group of even-numbered columns of said vertical shift registers,
said driver circuit sets the discharge timing of said information charge stored in said output section to an integral multiple of said horizontal transfer period, and
said driver circuit causes said output section to accumulate said information charge of multiple pixels.

6. The solid state imaging apparatus according to claim 5, wherein said segments of said color filter are arranged so that the same color segments are located every other pixel along a line of said matrix of said pixels.

7. The solid state imaging apparatus according to claim 5, wherein an additional vertical transfer electrode is provided on the output end of either the odd-numbered columns or the even-numbered columns of said vertical shift registers, so that an additional bit is formed on said vertical shift registers.

8. The solid state imaging apparatus according to claim 7, wherein said driver circuit drives said additional vertical transfer electrode to shift timing of transfer of said information charge packets from said group of odd-numbered columns to said horizontal shift register by half of the horizontal scanning period from that of said group of even-numbered columns.

9. The solid state imaging apparatus according to claim 5, wherein said driver circuit shifts said discharge timing of said output section by a predetermined fraction of said horizontal transfer period for each predetermined integral multiple of said horizontal or vertical scanning period of said solid state imaging device.

10. The solid state imaging apparatus according to claim 5, wherein said driver circuit causes said discharge operation of said output section at an integral multiple of said horizontal transfer period.

11. The solid state imaging apparatus according to claim 5, further comprising a signal level detecting circuit for sampling the output signal from said output section, wherein:
said signal level detecting circuit samples the output signal at the same frequency as the discharge operation of said information charge stored in said output section, and detects a signal level corresponding to said information charge of multiple pixels stored in said output section.
